(19) United States
(12) Patent Application Publication
(10) Pub. No.: US 2025/0233177 A1
(43) Pub. Date: Jul. 17, 2025

(54) FUEL CELL SYSTEM

(71) Applicant: TOYOTA JIDOSHA KABUSHIKI KAISHA, Toyota-shi (JP)

(72) Inventor: Masaya YANO, Okazaki-shi (JP)

(21) Appl. No.: 19/013,245

(22) Filed: Jan. 8, 2025

(30) Foreign Application Priority Data
Jan. 17, 2024 (JP) 2024-005348

(51) Int. Cl. H01M 8/04701; H01M 8/04029; H01M 8/04302; H01M 8/0432; H01M 8/04746

(52) U.S. Cl. CPC H01M 8/04723; H01M 8/04029; H01M 8/04302; H01M 8/04358; H01M 8/04768

(57) ABSTRACT

To provide a fuel cell system capable of efficiently warming up fuel cell stacks. A fuel cell system, wherein the fuel cell system comprises fuel cell stacks, a cooling system and a control unit; wherein the fuel cell stacks comprise at least a first fuel cell stack and a second fuel cell stack; wherein the cooling system comprises a first cooling water pipe, a second cooling water pipe, a cooler, a first connecting pipe, and a second connecting pipe.

### TECHNICAL FIELD

The disclosure relates to a fuel cell system.

### BACKGROUND

Various studies have been proposed for fuel cells (FC) as disclosed in Patent Document 1.

Patent Document 1: Japanese Patent Application Laid-Open (JP-A) No. 2023-102005

Patent Document 1 discloses a fuel cell system comprising fuel cell stacks, each of which is provided with a cooler.

In the related art, when fuel cell stacks are warmed up at the time of start-up below the freezing point, there is a possibility of deterioration in fuel efficiency.

### SUMMARY

The disclosure was achieved in light of the above circumstances. An object of the disclosure is to provide a fuel cell system configured to efficiently warm up fuel cell stacks.

That is, the present disclosure includes the following embodiments.
<1> A fuel cell system,
   wherein the fuel cell system comprises fuel cell stacks, a cooling system and a control unit;
   wherein the fuel cell stacks comprise at least a first fuel cell stack and a second fuel cell stack;
   wherein the cooling system comprises a first cooling water pipe, a second cooling water pipe, a cooler, a first connecting pipe and a second connecting pipe;
   wherein the first cooling water pipe connects the cooler and a cooling water inlet of the first fuel cell stack, and it connects a cooling water outlet of the first fuel cell stack and the cooler;
   wherein the second cooling water pipe connects the cooler and a cooling water inlet of the second fuel cell stack, and it connects a cooling water outlet of the second fuel cell stack and the cooler;
   wherein the first connecting pipe has a first connecting valve;
   wherein the first connecting pipe connects the first cooling water pipe and the second cooling water pipe to allow cooling water to bypass the cooler and be supplied from the first cooling water pipe to the second cooling water pipe when the first connecting valve is opened;
   wherein the second connecting pipe has a second connecting valve;
   wherein the second connecting pipe connects the first cooling water pipe and the second cooling water pipe to allow cooling water to bypass the cooler and be supplied from the second cooling water pipe to the first cooling water pipe when the second connecting valve is opened;
   wherein, when a cooling water temperature of at least the first fuel cell stack among the fuel cell stacks, is not below the freezing point at the time of starting up the fuel cell system below the freezing point, the control unit is configured to perform a normal start of the first fuel cell stack and then open the first connecting valve;
   wherein, when cooling water temperatures of all of the fuel cell stacks are below the freezing point at the time of starting up the fuel cell system below the freezing point, the control unit is configured to compare the cooling water temperatures of the fuel cell stacks;
   wherein, when the cooling water temperature of the first fuel cell stack is highest among the fuel cell stacks, the control unit is configured to perform a predetermined warm-up of the first fuel cell stack; thereafter, when the cooling water temperature of the first fuel cell stack becomes equal to or higher than a predetermined temperature, the control unit is configured to open the first connecting valve; and
   wherein, when there is no difference between the cooling water temperatures of the fuel cell stacks, the control unit is configured to perform a predetermined warm-up of a fuel cell stack preliminarily determined as the first fuel cell stack; thereafter, when the cooling water temperature of the first fuel cell stack becomes equal to or higher than a predetermined temperature, the control unit is configured to open the first connecting valve.
<2> The fuel cell system according to <1>,
   wherein, when the cooling water temperatures of all of the fuel cell stacks is lower than the freezing point and −10° C. or higher at the time of starting up the fuel cell system below the freezing point, the control unit is configured not to compare the cooling water temperatures of the fuel cell stacks, and
   wherein the control unit is configured to perform a predetermined warm-up of a fuel cell stack preliminarily determined as the first fuel cell stack; thereafter, when the cooling water temperature of the first fuel cell stack becomes 0° C. or higher, the control unit is configured to open the first connecting valve.
<3> The fuel cell system according to <1> or <2>,
   wherein the first connecting pipe branches from the first cooling water pipe upstream of the cooler of the first cooling water pipe, and it merges with the second cooling water pipe downstream of the cooler of the second cooling water pipe.
<4> The fuel cell system according to any one of <1> to <3>,
   wherein the second connecting pipe branches from the second cooling water pipe downstream of the cooler of the second cooling water pipe, and it merges with the first cooling water pipe upstream of the cooler of the first cooling water pipe.
<5> The fuel cell system according to any one of <1> to <4>,
   wherein the first cooling water pipe has a first bypass pipe;
   wherein the first bypass pipe has a first bypass valve;
   wherein the first bypass pipe branches from the first cooling water pipe upstream of the cooler of the first cooling water pipe, merges with the first cooling water pipe downstream of the cooler of the first cooling water pipe, and bypasses the cooler,
   wherein the second cooling water pipe has a second bypass pipe;
   wherein the second bypass pipe has a second bypass valve; and
   wherein the second bypass pipe branches from the second cooling water pipe upstream of the cooler of the second cooling water pipe, merges with the second cooling water pipe downstream of the cooler of the second cooling water pipe, and bypasses the cooler.

The fuel cell system of the present disclosure is configured to efficiently warm up fuel cell stacks.

### BRIEF DESCRIPTION OF THE DRAWINGS

In the accompanying drawings,

FIG. 1 is a system configuration diagram illustrating an example of the fuel cell system of the present disclosure during normal operation;

FIG. 2 is a system configuration diagram illustrating an example of the fuel cell system of the present disclosure at the time of start-up below the freezing point;

FIG. 3 is a system configuration diagram illustrating another example of the fuel cell system of the present disclosure at the time of start-up below the freezing point;

FIG. 4 is a flowchart illustrating an example of the control of the fuel cell system of the present disclosure; and

FIG. 5 is a flowchart illustrating another example of the control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, a reaction gas supplied to the anode of the fuel cell is a fuel gas (anode gas), and the reaction gas supplied to the cathode of the fuel cell is an oxidant gas (cathode gas). The fuel gas is a gas mainly containing hydrogen, and may be hydrogen. The oxidant gas is a gas containing oxygen, and may be oxygen, air, or the like.

In the present disclosure, there is provided a fuel cell system,
wherein the fuel cell system comprises fuel cell stacks, a cooling system and a control unit;
wherein the fuel cell stacks comprise at least a first fuel cell stack and a second fuel cell stack;
wherein the cooling system comprises a first cooling water pipe, a second cooling water pipe, a cooler, a first connecting pipe and a second connecting pipe;
wherein the first cooling water pipe connects the cooler and a cooling water inlet of the first fuel cell stack, and it connects a cooling water outlet of the first fuel cell stack and the cooler;
wherein the second cooling water pipe connects the cooler and a cooling water inlet of the second fuel cell stack, and it connects a cooling water outlet of the second fuel cell stack and the cooler;
wherein the first connecting pipe has a first connecting valve;
wherein the first connecting pipe connects the first cooling water pipe and the second cooling water pipe to allow cooling water to bypass the cooler and be supplied from the first cooling water pipe to the second cooling water pipe when the first connecting valve is opened;
wherein the second connecting pipe has a second connecting valve;
wherein the second connecting pipe connects the first cooling water pipe and the second cooling water pipe to allow cooling water to bypass the cooler and be supplied from the second cooling water pipe to the first cooling water pipe when the second connecting valve is opened;
wherein, when a cooling water temperature of at least the first fuel cell stack among the fuel cell stacks, is not below the freezing point at the time of starting up the fuel cell system below the freezing point, the control unit is configured to perform a normal start of the first fuel cell stack and then open the first connecting valve;
wherein, when cooling water temperatures of all of the fuel cell stacks are below the freezing point at the time of starting up the fuel cell system below the freezing point, the control unit is configured to compare the cooling water temperatures of the fuel cell stacks;
wherein, when the cooling water temperature of the first fuel cell stack is highest among the fuel cell stacks, the control unit is configured to perform a predetermined warm-up of the first fuel cell stack; thereafter, when the cooling water temperature of the first fuel cell stack becomes equal to or higher than a predetermined temperature, the control unit is configured to open the first connecting valve; and
wherein, when there is no difference between the cooling water temperatures of the fuel cell stacks, the control unit is configured to perform a predetermined warm-up of a fuel cell stack preliminarily determined as the first fuel cell stack; thereafter, when the cooling water temperature of the first fuel cell stack becomes equal to or higher than a predetermined temperature, the control unit is configured to open the first connecting valve.

In a fuel cell system in which two or more fuel cells are connected in parallel, when each fuel cell performs a low-efficiency warm-up at the time of starting the fuel cell system below the freezing point, the fuel efficiency at the time of low temperature deteriorates.

In the prior art, the bypass pipe of the cooler in the cooling system of each fuel cell is present, but the connecting pipe of the cooling system between the fuel cells is not present, and the cooling system as a whole is connected via the cooler.

When the heat generated by one fuel cell is transferred to the other fuel cell through the cooling pipe of the entire cooling system, the heat capacity increases, which is inefficient.

The present disclosure relates to a pipe configuration of a cooling system and a method of starting a fuel cell system corresponding to a subfreezing start in a fuel cell system connecting two or more fuel cells.

In the present disclosure, one fuel cell is heated by power generation, and heat generated in one fuel cell is transmitted to the other fuel cell.

The cooling water temperature of one of the fuel cells exceeds a predetermined temperature (for example, 30° C.), and the rotation speed of the water pump increases, and at the same time, the connecting valve between the fuel cells is opened.

When the fuel cell system is started up, the cooling water temperature of each fuel cell may be checked, and the fuel cell having the higher cooling water temperature may be started up.

The fuel cell system of the present disclosure may be mounted on a moving body such as a vehicle and used. Further, the fuel cell system of the present disclosure may be mounted in a stationary power generation system such as a generator that supplies electric power to the outside of the fuel cell system.

The vehicle may be a fuel cell vehicle or the like. Examples of the moving body other than the vehicle include a railway, a ship, and an aircraft.

Further, the fuel cell system of the present disclosure may be mounted on a moving body such as a vehicle capable of traveling even with electric power of a secondary battery.

The mobile body and the stationary power generation system may include the fuel cell system of the present disclosure. The moving body may include a drive unit such as a motor, an inverter, and a hybrid control system.

The hybrid control system may be capable of driving a moving body by using both the output of the fuel cell and the electric power of the secondary battery.

The fuel cell system includes a plurality of fuel cell stacks, a cooling system, and a control unit. The fuel cell system may include a fuel gas system, an oxidant gas system, and the like.

A fuel cell stack is a stacked body in which a plurality of unit cells of a fuel cell are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may include a current collector plate, a pressure plate, and the like at an end portion in the stacking direction.

The fuel cell system may include at least a first fuel cell stack and a second fuel cell stack as the plurality of fuel cell stacks, and may include three or more fuel cell stacks. The fuel cell system may include a number of fuel cell stacks in which the total power of the plurality of fuel cell stacks is of the order of 1 MW.

The unit cell may include a power generation unit.

The shape of the power generation unit may be a rectangular shape in a plan view.

The power generation unit may be a membrane electrode assembly (MEA) including an electrolyte membrane and two electrodes sandwiching the electrolyte membrane.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalytic layer, and may optionally include gas diffusion layer, and the power generation unit may be a membrane electrode gas diffusion layer assembly (MEGA). In this case, the unit cell may include a cathode separator, an anode separator, and a membrane electrode gas diffusion layer assembly disposed between the cathode separator and the anode separator.

The membrane electrode gas diffusion layer assembly includes an anode-side gas diffusion layer, an anode catalyst layer, an electrolyte membrane, a cathode catalyst layer, and a cathode-side gas diffusion layer in this order.

The anode catalyst layer and the cathode catalyst layer are collectively referred to as a catalyst layer.

The anode-side gas diffusion layer and the cathode-side gas diffusion layer are collectively referred to as a gas diffusion layer.

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell may include a separator.

The separator collects current generated by power generation and functions as a partition wall. The separator is usually disposed on both sides of the unit cell in the stacking direction of the power generation unit such that a pair of separators sandwich the power generation unit. One of the pair of separators is an anode separator and the other is a cathode separator.

The anode separator may have a groove that serves as a fuel gas flow path on a surface on the side of the power generation unit.

The cathode separator may have a groove that serves as an oxidant gas flow path on a surface on the side of the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, resins such as PE, PP, PET, and PEN can be used. The resin frame may be a three-layer sheet composed of three layers in which an adhesive layer is disposed on a surface layer.

The fuel cell stack may include a gasket, a resin sheet, and the like between the unit cells to seal each gas.

The cooling system supplies cooling water to the fuel cell as a cooling medium.

The cooling water may be water, ethylene glycol, or the like, or a mixture thereof.

The cooling system includes a first cooling water pipe, a second cooling water pipe, a cooler, a first connecting pipe, and a second connecting pipe, and may include a cooling water pump, a reserve tank, an ion exchanger, an intercooler, and the like as necessary.

The first cooling water pipe and the second cooling water pipe are collectively referred to as a cooling water pipe.

The first connecting pipe and the second connecting pipe are collectively referred to as a connecting pipe.

The first cooling water pipe connects the cooler to the cooling water inlet of the first fuel cell stack, and connects the cooling water outlet of the first fuel cell stack to the cooler.

The first cooling water pipe may include a first bypass pipe.

The first bypass pipe may include a first bypass valve.

The first bypass pipe may branch from the first cooling water pipe upstream of the cooler of the first cooling water pipe, may merge with the first cooling water pipe downstream of the cooler of the first cooling water pipe, and may bypass the cooler.

The first bypass valve performs flow path switching to switch whether the cooling water discharged from the first fuel cell stack flows to the cooler or the first bypass pipe. The first bypass valve may include an electric motor such as an electric actuator for switching the flow path.

The first cooling water pipe may have a first cooling water inlet valve. The first cooling water inlet valve may be disposed downstream of the cooler, may be disposed upstream of a junction portion of the first cooling water pipe with the first bypass pipe, or may be disposed upstream of a branch portion of the first cooling water pipe to the first connecting pipe.

The second cooling water pipe connects the cooler to the cooling water inlet of the second fuel cell stack, and connects the cooling water outlet of the second fuel cell stack to the cooler.

The second cooling water pipe may include a second bypass pipe.

The second bypass pipe may include a second bypass valve.

The second bypass pipe may branch from the second cooling water pipe upstream of the cooler of the second cooling water pipe, may merge with the second cooling water pipe downstream of the cooler of the second cooling water pipe, and may bypass the cooler.

The second bypass valve performs flow path switching to switch whether the cooling water discharged from the second fuel cell stack flows to the cooler or the second bypass pipe. The second bypass valve may include an electric motor such as an electric actuator for switching the flow path.

The second cooling water pipe may have a second cooling water inlet valve. The second cooling water inlet valve may be disposed downstream of the cooler, may be disposed upstream of the junction portion of the second cooling water pipe with the second bypass pipe, or may be disposed upstream of the branch portion of the second cooling water pipe with respect to the second connecting pipe.

The first connecting pipe has a first connecting valve.

The first connecting pipe connects the first cooling water pipe and the second cooling water pipe. The first connecting pipe bypasses the cooler when the first connecting valve is opened, and allows the cooling water to be supplied from the first cooling water pipe to the second cooling water pipe. The first connecting pipe does not supply the cooling water from the first cooling water pipe to the second cooling water pipe when the first connecting valve is closed.

The connection point between the first cooling water pipe and the second cooling water pipe of the first connecting pipe is not particularly limited. From the viewpoint of efficiently warming up a plurality of fuel cell stacks, the first cooling water pipe may be branched from the first cooling water pipe upstream of the cooler of the first cooling water pipe, and may be combined with the second cooling water pipe downstream of the cooler of the second cooling water pipe. The branch portion of the first connecting pipe from the first cooling water pipe may be upstream of the branch portion of the first bypass pipe from the first cooling water pipe. The merging portion of the first connecting pipe to the second cooling water pipe may be downstream of the merging portion of the second bypass pipe to the second cooling water pipe. The junction portion of the first connecting pipe to the second cooling water pipe may be downstream of the branch portion of the second connecting pipe from the second cooling water pipe.

The first connecting valve performs flow path switching to switch whether the cooling water discharged from the first fuel cell stack flows to the cooler or the first fuel cell stack or the second cooling water pipe.

The first connecting valve may include an electric motor such as an electric actuator for switching the flow path.

The second connecting pipe has a second connecting valve.

The second connecting pipe connects the first cooling water pipe and the second cooling water pipe. The second connecting pipe bypasses the cooler when the second connecting valve is opened, and allows the cooling water to be supplied from the second cooling water pipe to the first cooling water pipe. The second connecting pipe does not supply the cooling water from the second cooling water pipe to the first cooling water pipe when the second connecting valve is closed.

The connection point between the first cooling water pipe and the second cooling water pipe of the second connecting pipe is not particularly limited. From the viewpoint of efficiently warming up a plurality of fuel cell stacks, the second cooling water pipe may be branched from the second cooling water pipe downstream of the cooler of the second cooling water pipe, and may be combined with the first cooling water pipe upstream of the cooler of the first cooling water pipe. The branch portion of the second connecting pipe from the second cooling water pipe may be downstream of the junction portion of the second bypass pipe to the second cooling water pipe. The junction portion of the second connecting pipe to the first cooling water pipe may be upstream of the branch portion of the first bypass pipe from the first cooling water pipe. The junction portion of the second connecting pipe to the first cooling water pipe may be downstream of the branch portion of the first connecting pipe from the first cooling water pipe.

The second connecting valve performs flow path switching to switch whether the cooling water discharged from the second fuel cell stack flows to the cooler or the second fuel cell stack, or flows to the first cooling water pipe. The second connecting valve may include an electric motor such as an electric actuator for switching the flow path.

The cooling water pump circulates cooling water for cooling the fuel cell and adjusts a flow rate of the cooling water supplied to the fuel cell.

The reserve tank is a tank for temporarily storing cooling water overflowing from a cooling water pipe whose internal pressure has increased due to an increase in temperature of the cooling water.

The cooler is disposed on the cooling water pipe to cool the cooling water. Examples of the cooler include a radiator. The cooler may be shared by the first cooling water pipe and the second cooling water pipe. The cooler may be provided separately in the first cooling water pipe and the second cooling water pipe. That is, the first cooling water pipe may be connected to the first cooler, and the second cooling water pipe may be connected to the second cooler.

The oxidizing gas system supplies an oxidizing gas containing oxygen to the fuel cell and adjusts a flow rate of the oxidizing gas. The oxidant gas system may include an oxidant gas supply device, an oxidant gas pipe, an inlet-side sealing valve at an oxidant gas inlet of the fuel cell, an outlet-side sealing valve at an oxidant gas outlet of the fuel cell, and the like.

The oxidant gas supply device may be an air compressor or the like.

The fuel gas system supplies a fuel gas containing hydrogen necessary for power generation of the fuel cell to the fuel cell, and adjusts a flow rate of the fuel gas. The fuel gas system may include a fuel gas tank, a fuel gas inlet valve, an injector, a gas-liquid separator, an exhaust water valve, an ejector for circulating fuel gas, a fuel gas pump for circulating fuel gas, a fuel gas pipe, and the like.

The fuel cell system may include a secondary battery.

The secondary battery may be any battery that can be charged and discharged, and examples thereof include a nickel-hydrogen secondary battery and a conventionally known secondary battery such as a lithium-ion secondary battery. The secondary battery may include a power storage element such as an electric double layer capacitor. The secondary battery may have a configuration in which a plurality of the secondary batteries are connected in series. The secondary battery supplies electric power to an air compressor or the like. The secondary battery may be rechargeable from an external power source of the fuel cell system, such as a household power source. The secondary battery may be charged by the output of the fuel cell. The charging and discharging of the secondary battery may be controlled by the control unit.

The fuel cell system includes a control unit. The control unit may control the oxidant gas system, the fuel gas system, the cooling system, and the like to control the entire fuel cell system.

The control unit physically includes, for example, an arithmetic processing unit such as a central processing unit (CPU), a ROM (read-only memory) that stores control programs and control data to be processed by CPU, a storage device such as a RAM (random access memory) that is mainly used as various working areas for the control processing, and an input/output interface, and may be a ECU (electronic control unit).

When the cooling water temperature of at least the first fuel cell stack among the plurality of fuel cell stacks is not below the freezing point during the sub-freezing start of the fuel cell system, the control unit performs the normal start of the first fuel cell stack, and then opens the first connecting valve. At this time, the control unit may open the second connecting valve.

Opening the first connecting valve in the present disclosure means that the cooling water flows from the first cooling water pipe through the first connecting pipe to the second cooling water pipe.

Opening the second connecting valve in the present disclosure means that the cooling water flows from the second cooling water pipe through the second connecting pipe to the first cooling water pipe.

When the cooling water temperature of all of the fuel cell stacks among the plurality of fuel cell stacks is below the freezing point at the time of start-up under the freezing point of the fuel cell system, the control unit compares the cooling water temperatures of the plurality of fuel cell stacks.

When the cooling water temperature of the first fuel cell stack among the plurality of fuel cell stacks is highest, the control unit performs a predetermined warm-up of the first fuel cell stack. Thereafter, when the cooling water temperature of the first fuel cell stack becomes equal to or higher than the predetermined temperature, the control unit opens the first connecting valve.

At this time, the control unit may open the second connecting valve.

When there is no temperature difference between the cooling water temperatures of the plurality of fuel cell stacks, the control unit performs predetermined warm-up of the first fuel cell stack. Thereafter, when the cooling water temperature of the first fuel cell stack becomes equal to or higher than the predetermined temperature, the control unit opens the first connecting valve. At this time, the control unit may open the second connecting valve.

The predetermined temperature is not particularly limited, but may be 0° C. or higher.

When the cooling water temperature of all of the fuel cell stacks among the plurality of fuel cell stacks is below the freezing point and −10° C. or higher at the start-up under the freezing point of the fuel cell system, the control unit may not compare the cooling water temperatures of the plurality of fuel cell stacks.

In the above case, the control unit may perform predetermined warm-up of the first fuel cell stack, and then, when the cooling water temperature of the first fuel cell stack becomes 0° C. or higher, the control unit may open the first connecting valve. At this time, the control unit may open the second connecting valve.

When the cooling water temperatures of the plurality of fuel cell stacks are both high than −10° C. at the time of the sub-freezing start of the fuel cell system, since there is little difference in the startability of the fuel cell stack, the determination of the fuel cell stack to be started may not be performed, and a predetermined warm-up of the first fuel cell stack may be performed.

The predetermined first fuel cell stack may be a fuel cell stack that is the least degraded of the plurality of fuel cell stacks. The degradation degree of the fuel cell stack may be determined based on the total operating time of the fuel cell stack, the voltage of the fuel cell stack, and the like.

The fuel cell stack with the shortest total operating time may be the least degraded fuel cell stack.

The fuel cell stack having the highest voltage may be the fuel cell stack having the least deteriorated voltage.

In a case where cooling systems having different lengths of the cooling water pipes are combined, the fuel cell stack of the cooling system having a smaller cooling water capacity may be a predetermined first fuel cell stack.

The fuel cell system may comprise a temperature sensor.

The temperature of the cooling water may be measured by a temperature sensor. The temperature of the cooling water may be the temperature of the cooling water on the inlet side of the fuel cell stack or the temperature of the cooling water on the outlet side of the fuel cell stack.

The control unit may determine whether or not the temperature of the cooling water measured by the temperature sensor is below the freezing point at the time of starting the fuel cell system or at all times.

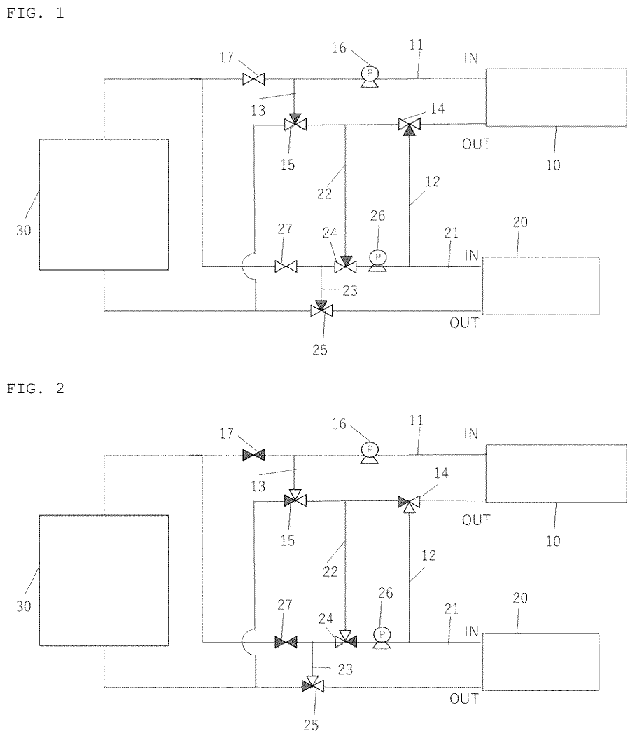

FIG. 1 is a system configuration diagram illustrating an example of a fuel cell system of the present disclosure during normal operation.

The fuel cell system of the present disclosure includes a first fuel cell stack 10, a second fuel cell stack 20, and a cooling system. Although not shown, the fuel cell system may include a control unit, a fuel gas system, an oxidant gas system, and the like.

The cooling system includes a first cooling water pipe 11, a second cooling water pipe 21, a cooler 30, a first connecting pipe 12, a second connecting pipe 22, a first bypass pipe 13, a first connecting valve 14, a first bypass valve 15, a second bypass pipe 23, a second connecting valve 24, a second bypass valve 25, a first cooling water pump 16, a second cooling water pump 26, a first cooling water inlet valve 17, and a second cooling water inlet valve 27.

During normal operation of the fuel cell system, the first cooling water inlet valve 17 and the second cooling water inlet valve 27 are opened. The first connecting pipe 12 side of the first connecting valve 14 is closed, and the first cooling water pipe 11 upstream and downstream side is opened. The first bypass pipe 13 side of the first bypass valve 15 is closed, and the first cooling water pipe 11 upstream and downstream side is opened. The second connecting pipe 22 side of the second connecting valve 24 is closed, and the second cooling water pipe 21 upstream and downstream side is opened. The second bypass pipe 23 side of the second bypass valve 25 is closed, and the second cooling water pipe 21 upstream and downstream side is opened.

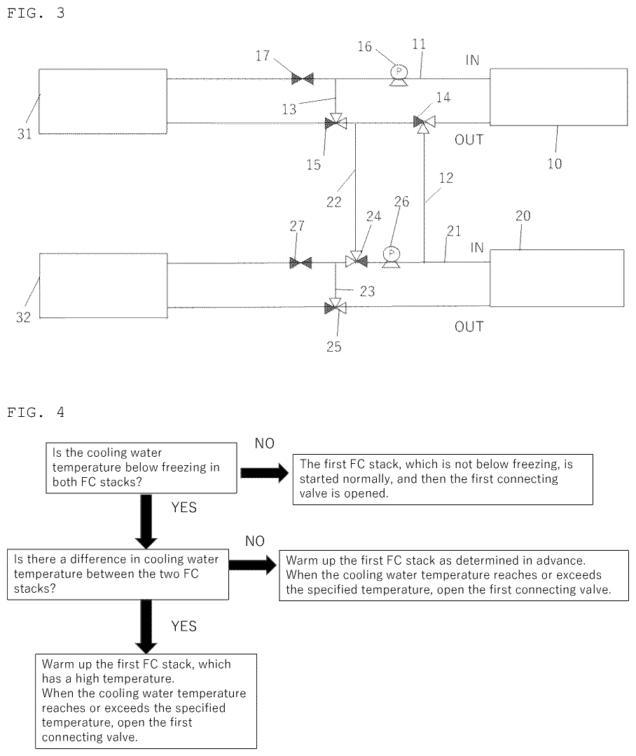

FIG. 2 is a system configuration diagram illustrating an example of a fuel cell system according to the present disclosure at the time of sub-freezing start. In FIG. 2, the same components as those in FIG. 1 are denoted by the same reference numerals, and description thereof will be omitted.

During sub-freezing start of the fuel cell system, the first cooling water inlet valve 17 and the second cooling water inlet valve 27 are closed. The downstream side of the first cooling water pipe 11 of the first connecting valve 14 is closed, and the upstream side of the first cooling water pipe 11 and the first connecting pipe 12 side are opened. The downstream side of the first cooling water pipe 11 of the first bypass valve 15 is closed, and the upstream side of the first cooling water pipe 11 and the first bypass pipe 13 side are opened. The downstream side of the second cooling water pipe 21 of the second connecting valve 24 is closed, and the upstream side of the second cooling water pipe 21 and the second connecting pipe 22 side are opened. The downstream side of the second cooling water pipe 21 of the second bypass valve 25 is closed, and the upstream side of the second cooling water pipe 21 and the second bypass pipe 23 side are opened.

FIG. 3 is a system configuration diagram illustrating another example of a fuel cell system according to the present disclosure at the time of sub-freezing start. In FIG. 3, the same components as those in FIG. 1 are denoted by the same reference numerals, and description thereof will be omitted. The fuel cell system shown in FIG. 3 includes a first cooler 31 and a second cooler 32 instead of the cooler 30.

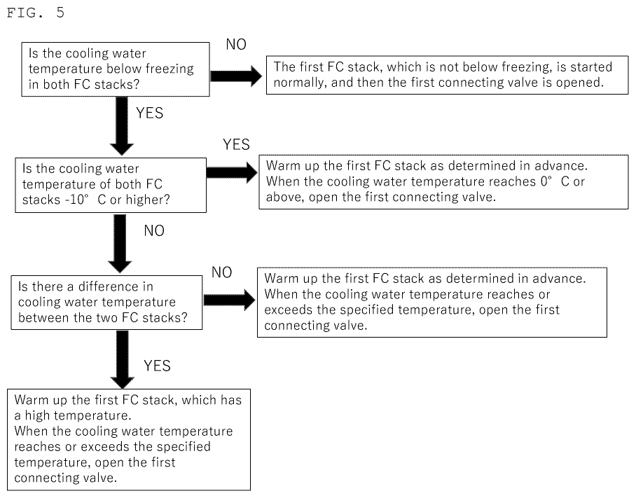

FIG. 4 is a flowchart illustrating an example of control of the fuel cell system of the present disclosure.

The control unit determines whether the cooling water temperatures of the two fuel cell stacks are below freezing point.

If the cooling water temperature of any of the two fuel cell stacks is not below freezing point, the control unit normally starts the two fuel cell stacks.

When the cooling water temperature of one of the two fuel cell stacks is not below the freezing point, the control unit normally starts the first fuel cell stack, and then opens the first connecting valve of the first connecting pipe of the first fuel cell stack to supply the cooling water to the second cooling water pipe. At this time, the control unit may open the second connecting valve.

If, among the two fuel cell stacks, the cooling water temperature of both of the two fuel cell stacks is below the freezing point, the control unit determines whether there is a temperature difference between the cooling water temperatures of the two fuel cell stacks.

When there is no temperature difference between the cooling water temperatures of the two fuel cell stacks, the control unit performs predetermined warm-up of the first fuel cell stack. Thereafter, when the cooling water temperature of the first fuel cell stack becomes equal to or higher than a predetermined temperature, the control unit opens the first connecting valve and supplies the cooling water to the second cooling water pipe. At this time, the control unit may open the second connecting valve.

When there is a temperature difference between the cooling water temperatures of the two fuel cell stacks and the cooling water temperature of the first fuel cell stack is higher than the cooling water temperature of the second fuel cell stack, the control unit performs a predetermined warm-up of the first fuel cell stack. Thereafter, when the cooling water temperature of the first fuel cell stack becomes equal to or higher than the predetermined temperature, the control unit opens the first connecting valve and supplies the cooling water to the second cooling water pipe. At this time, the control unit may open the second connecting valve.

FIG. 5 is a flowchart illustrating another example of control of the fuel cell system of the present disclosure.

The control unit determines whether the cooling water temperatures of the two fuel cell stacks are below freezing point.

If, among the two fuel cell stacks, the cooling water temperature of both of the two fuel cell stacks is below the freezing point, the control unit determines whether the cooling water temperature of the two fuel cell stacks of the two fuel cell stacks is below the freezing point and above −10° C.

When the cooling water temperature of both of the two fuel cell stacks among the two fuel cell stacks is lower than the freezing point and equal to or higher than −10° C., the control unit does not compare the cooling water temperatures of the two fuel cell stacks, and the control unit performs predetermined warm-up of the first fuel cell stack.

Thereafter, when the cooling water temperature of the first fuel cell stack reaches 0° C. or higher, the control unit opens the first connecting valve and supplies the cooling water to the second cooling water pipe. At this time, the control unit may open the second connecting valve.

### REFERENCE SIGNS LIST

10 First fuel cell stack
11 First cooling water pipe
12 First connecting pipe
13 First bypass pipe
14 First connecting valve
15 First bypass valve
16 First cooling water pump
17 First cooling water inlet valve
20 Second fuel cell stack
21 Second cooling water pipe
22 Second connecting pipe
23 Second bypass pipe
24 Second connecting valve
25 Second bypass valve
26 Second cooling water pump
27 Second cooling water inlet valve
30 Cooler
31 First cooler
32 Second cooler

1. A fuel cell system,
wherein the fuel cell system comprises fuel cell stacks, a cooling system and a control unit;
wherein the fuel cell stacks comprise at least a first fuel cell stack and a second fuel cell stack;
wherein the cooling system comprises a first cooling water pipe, a second cooling water pipe, a cooler, a first connecting pipe and a second connecting pipe;
wherein the first cooling water pipe connects the cooler and a cooling water inlet of the first fuel cell stack, and it connects a cooling water outlet of the first fuel cell stack and the cooler;
wherein the second cooling water pipe connects the cooler and a cooling water inlet of the second fuel cell stack, and it connects a cooling water outlet of the second fuel cell stack and the cooler;
wherein the first connecting pipe has a first connecting valve;
wherein the first connecting pipe connects the first cooling water pipe and the second cooling water pipe to allow cooling water to bypass the cooler and be supplied from the first cooling water pipe to the second cooling water pipe when the first connecting valve is opened;
wherein the second connecting pipe has a second connecting valve;
wherein the second connecting pipe connects the first cooling water pipe and the second cooling water pipe to allow the cooling water to bypass the cooler and be supplied from the second cooling water pipe to the first cooling water pipe when the second connecting valve is opened;
wherein, when a cooling water temperature of at least the first fuel cell stack among the fuel cell stacks, is not below the freezing point at the time of starting up the fuel cell system below the freezing point, the control unit is configured to perform a normal start of the first fuel cell stack and then open the first connecting valve;
wherein, when cooling water temperatures of all of the fuel cell stacks are below the freezing point at the time of starting up the fuel cell system below the freezing point, the control unit is configured to compare the cooling water temperatures of the fuel cell stacks;
wherein, when the cooling water temperature of the first fuel cell stack is highest among the fuel cell stacks, the control unit is configured to perform a predetermined warm-up of the first fuel cell stack; thereafter, when the cooling water temperature of the first fuel cell stack becomes equal to or higher than a predetermined temperature, the control unit is configured to open the first connecting valve; and
wherein, when there is no difference between the cooling water temperatures of the fuel cell stacks, the control unit is configured to perform a predetermined warm-up of a fuel cell stack preliminarily determined as the first fuel cell stack; thereafter, when the cooling water temperature of the first fuel cell stack becomes equal to or higher than a predetermined temperature, the control unit is configured to open the first connecting valve.

2. The fuel cell system according to claim 1,
wherein, when the cooling water temperatures of all of the fuel cell stacks is lower than the freezing point and −10° C. or higher at the time of starting up the fuel cell system below the freezing point, the control unit is configured not to compare the cooling water temperatures of the fuel cell stacks, and
wherein the control unit is configured to perform a predetermined warm-up of a fuel cell stack preliminarily determined as the first fuel cell stack; thereafter, when the cooling water temperature of the first fuel cell stack becomes 0° C. or higher, the control unit is configured to open the first connecting valve.

3. The fuel cell system according to claim 1,
wherein the first connecting pipe branches from the first cooling water pipe upstream of the cooler of the first cooling water pipe, and it merges with the second cooling water pipe downstream of the cooler of the second cooling water pipe.

4. The fuel cell system according to claim 1,
wherein the second connecting pipe branches from the second cooling water pipe downstream of the cooler of the second cooling water pipe, and it merges with the first cooling water pipe upstream of the cooler of the first cooling water pipe.

5. The fuel cell system according to claim 1,
wherein the first cooling water pipe has a first bypass pipe;
wherein the first bypass pipe has a first bypass valve;
wherein the first bypass pipe branches from the first cooling water pipe upstream of the cooler of the first cooling water pipe, merges with the first cooling water pipe downstream of the cooler of the first cooling water pipe, and bypasses the cooler;
wherein the second cooling water pipe has a second bypass pipe;
wherein the second bypass pipe has a second bypass valve; and
wherein the second bypass pipe branches from the second cooling water pipe upstream of the cooler of the second cooling water pipe, merges with the second cooling water pipe downstream of the cooler of the second cooling water pipe, and bypasses the cooler.
